(19) United States
(12) Patent Application Publication
(10) Pub. No.: US 2014/0056013 A1
(43) Pub. Date: Feb. 27, 2014

(54) LOW PROFILE BOAT NAVIGATION LIGHTS

(71) Applicants: Thomas Douglas HANCOCK, JR., Isle of Palms, SC (US); Dale Leslie MARTIN, North Charleston, SC (US)

(72) Inventors: Thomas Douglas HANCOCK, JR., Isle of Palms, SC (US); Dale Leslie MARTIN, North Charleston, SC (US)

(21) Appl. No.: 13/590,628

(22) Filed: Aug. 21, 2012

(51) Int. Cl. B63B 45/02; F21V 9/08

(52) U.S. Cl. 362/477

(57) ABSTRACT

Low profile navigation lights for a boat are provided, wherein the navigation lights are inset or recessed within a mount, which may be positioned along or within a rubrail of a boat. Each mount is preferably made from a tough, rigid material, such as metal or hard plastic, and includes a hole for receiving the light bulb and protective cover. The navigation lights are recessed within the mount, so that the mount serves to protect the lights against bumps or collisions against docks, piers, other vessels, and the like.

### BACKGROUND OF THE INVENTION

The present invention relates generally to navigation lights for boats. More specifically, the present invention includes a low profile set of navigation lights positioned near the bow of a boat, preferably along or within the rubrail thereof.

Many different types of navigation lights for boats are available on the market today. Such lights are required on most boats, so that the boat is visible to other boats in the vicinity, and as a way for boat captains to determine who has the right-of way.

U.S. Patent Application Publication No. 2010/0118557 is directed to an LED lighting system for watercraft, including LED lighting assemblies inserted into tubular members and inserted within rub rails mounted along the gunwale or wall of the hull, along the starboard and port sides, bow and stern. The LED lighting assembly can include ultraviolet LEDS for night fishing, white-light LEDs, a red LED port-running light, and a green LED starboard-running light. The string of LED lights can be pre-assembled into conventional insert tubing, and inserted into the cavities of the rub rail to emit the desired LED light from within the rub rail.

U.S. Pat. No. 7,258,472 discloses an illuminated bumper assembly having an elongated light source for emitting light rays and an elongated bumper for carrying the elongated light source. The elongated bumper is adapted to allow light rays from the elongated light source to be emitted along its length. In some embodiments, the elongated bumper has a primary bumper surface that faces away from a protected surface, and the elongated bumper is structured to engage one or more approaching objects and at least partially protect the protected surface from the one or more approaching objects. In some cases, the elongated light source may be situated between the primary bumper surface and the protected surface such that the primary bumper surface also helps protect the elongated light source from the one or more objects. The illuminated bumper may be adapted for use on boats and/or other applications, as desired.

U.S. Pat. No. 6,371,634 describes a boat side light for illuminating the side of a boat at night. The boat side light includes one or more light sources for generating light rays, and a directing means for directing the light rays toward the side of the boat. A number of configurations are contemplated, including one or more light assemblies that are provided along the side of the boat. Alternatively, an elongated carrier may be provided that extends around at least a portion of the periphery of the boat, the elongated carrier may or may not have a bumper included therewith.

U.S. Pat. No. 6,231,217 is directed to a lighting system for a watercraft which provides a visual indication of the watercraft at a distance during darkness or other inclement conditions. The lighting system comprises a light source or a plurality of light sources which are directed to directly illuminate the hull of the watercraft such that a distinct portion or portions of the hull is directly illuminated and visually identifiable at a distance. Preferably, the port side of the hull is directly illuminated by a red light, the starboard side of the hull is illuminated green and the stern portion of the hull is illuminated yellow so that one observing the watercraft can determine the correct orientation of the watercraft relative to the observer's position. The light source which directly illuminates the hull of the watercraft is also designed to intermittently flash or strobe based upon the movement of the watercraft, or lack thereof.

U.S. Design Patent No. D596,090 discloses an ornamental design for an illuminated rubrail on a boat, as shown and described therein. Each of the references listed above is hereby incorporated herein by reference.

Each of these prior lighting systems includes disadvantages. Specifically, some of these devices include longitudinal arrays of lights, which must be replaced in their entirety when any single bulb burns out. Secondly, while some of these devices are inserted into the rubrail, most do not include any type of protective casing or mount that protects the lights when the rubrail inadvertently comes into contact with a dock, pier, or other vessel, as the rubber rubrail itself provides limited protection. Additionally, the longitudinal lighting arrays can be confusing to other boaters, who are more accustomed to seeing individual navigation lights.

Thus, it would be desirable to provide a navigation lighting system, wherein individual navigation lights are installed within or along the rubrail on or adjacent the bow of the boat, wherein the navigation lights include a rigid mount assembly for protection of the lights. Additionally, it is desirable to provide such low profile navigation lights, which do not protrude from the top or sides of the boat, and thereby do not interfere with fishing lines, anchor lines or mooring lines.

### BRIEF SUMMARY OF THE INVENTION

In accordance with one aspect of the invention, low profile navigation lights for a boat are provided, wherein the navigation lights are inset or recessed within a mount, which may be positioned along or within a rubrail of a boat. Each mount is preferably made from a tough, rigid material, such as metal or hard plastic, and includes a hole for receiving the light bulb and protective cover. The port side navigation light is green, while the starboard navigation light is red, in accordance with customary boating navigation rules. The navigation lights are recessed within the mount, so that the mount serves to protect the lights against bumps or collisions against docks, piers, other vessels, and the like.

Because the low profile navigation lights do not protrude outwardly from the top or sides of the boat or deck, they do not interfere with anchor lines, fishing lines, mooring lines, trolling motors, or other standard boating or fishing equipment. Additionally, this design reduces or eliminates the possibility of glare from the light upon the eyes of the boat's occupants, and is easily installed into new or existing watercraft. In a preferred embodiment, the lights are light-emitting-diodes (LED), which provides a bright, energy efficient navigation light, whose operational life tends to me much longer than conventional light bulbs. Further, the lights may be replaced while the mounting member remains in place, so that it is not necessary to remove the mount member from the rubrail of the boat in order to change a light that has burned out.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a boat, and further illustrating one embodiment of the low profile boat navigation light installed thereon along the rubrail;

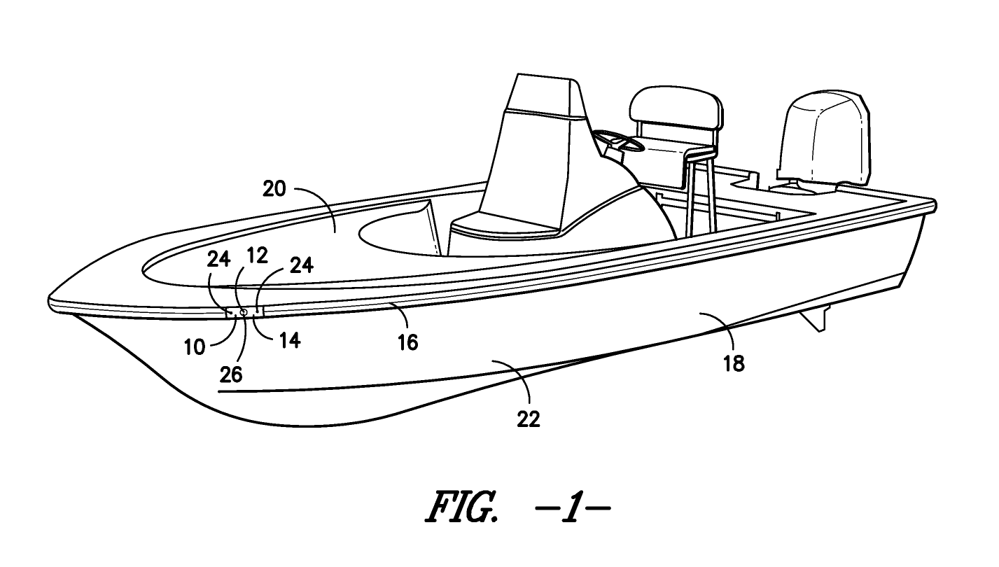

FIG. 2 is a perspective view of a boat, and further illustrating another embodiment wherein a pair of low profile boat navigation lights is installed on one side thereof

FIG. 3 is a perspective view of a rubrail of a boat having one embodiment of the low profile boat navigation lights installed thereon.

### DETAILED DESCRIPTION OF THE INVENTION

The present invention includes, in a first embodiment, a low profile boat navigation light assembly 10, wherein the lights 12 are recessed within a protective mount member 14, which is mounted on or within the rubrail 16 that extends largely around the periphery of a boat 18. In accordance with one aspect of the invention, the lights 12 are light-emitting-diodes, and are recessed within the mount member 14, so that the lights 12 do not protrude outwardly from the deck 20 or the sides 22 of the boat 18, as conventional navigation lights typically do.

The mount member 14 may take several forms, although it is preferably made from a hard, tough material, such as metal or hard plastic. The mount member 14, in a preferred embodiment, includes a hole in the middle portion thereof, for receiving the light 12. Mounting holes 24 are preferably positioned on either side of the light 12, and a protective covering 26 may be disposed over the light 12 to prevent water or other objects from coming into contact with the light 12 or internal components of the navigation light assembly 10. The mount member 14 may be any desired shape that conforms to the contours of the boat 18 along the rubrail 16, and is preferably of monolithic, unitary design. In other words, it is preferred that the mount member 14 be manufactured from and consist of a single piece of material, rather than several pieces or components that are connected together. Although the preferred mounting means includes screws, it is contemplated that other means may be used for mounting the navigation light assembly 10, including adhesives, rivets, or snap-fit means.

The low profile navigation light assembly 10 includes standard wires (not shown) for connection to a power source, such as a battery (not shown) in the conventional manner. The lights 12 (preferably LED lights) are attached to an underside of the mount member 14, so that the light may shine through the hole in the mount member 14. The lights 12 may be colored lights (red on the port side and green on the starboard), or the lights 12 may simply be white lights with a colored, transparent protective covering 26, which causes the lights 12 to shine red or green, as desired or required. In a preferred embodiment, the navigation light assembly 10, including the light 12 and the mount member 14 (and optionally the protective cover 26), is waterproof or water resistant.

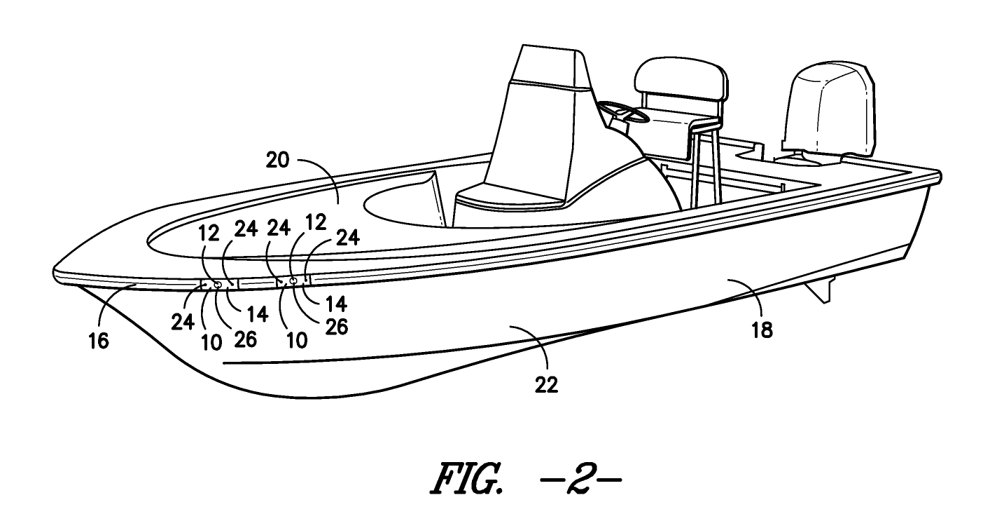

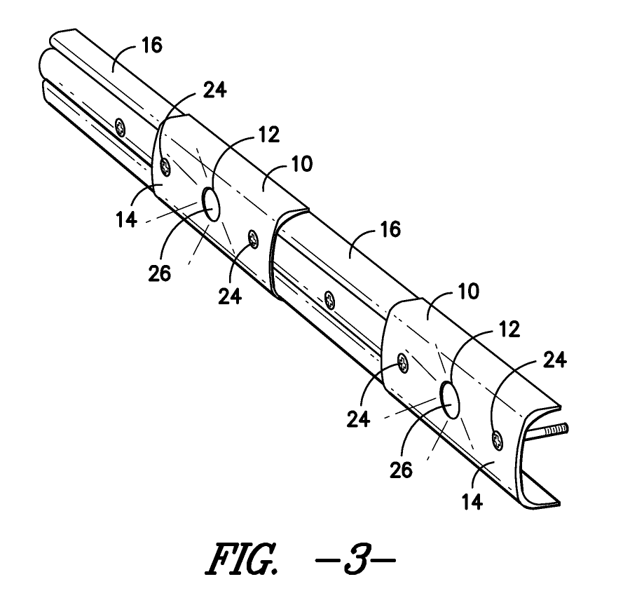

For purposes of installation, a small section of the rubrail 16 may be cut and removed so that the mount member 14 may be placed between sections of the rubrail 16. Preferably, the mount member 14 is disposed between sections of the rubrail 16 so that the mount member 14 is flush (or substantially flush) with the rubrail 16. Alternatively, the mount member 14 may be manufactured so that its shape, particularly the underside of the mount member 14, fits the contours of the rubrail 16, and is simply mounted over the rubrail 16. In that case, it may be necessary to drill a hole through the rubrail 16 in order to accommodate the light portion of the assembly 10. Additionally, it is contemplated that one assembly may be installed on each side of the boat 18 (red on port, green on starboard), or additional assemblies 10 may be installed on each side. Specifically, it is contemplated that two navigation light assemblies 10 may be positioned on each side of the boat 18 along the rubrail 16, as shown in FIGS. 2 and 3.

This arrangement allows navigation light assemblies 10 to be installed, either during the manufacturing process of a new boat, or as an after-market item. The mount member 14 acts as a protective shield or buffer that reduces or prevents damage to the lights 12, in the event that the boat 18 inadvertently bumps or scrapes against a dock, buoy, pier or the like. Additionally, the low profile nature of the navigation light assembly 10 prevents docking lines, anchor lines, fishing lines, and other objects from becoming hooked around or entangled with the navigation light assembly 10, and also eliminates the possibility that someone may stub a toe or trip over the navigation lights, as happens occasionally with conventional bow mounted lights. Further, because the navigation light assemblies 10 are mounted along the rubrail 16 of the boat 18, and the lights 12 face outwardly away from the boat 18, this navigation light assembly reduces or eliminates any glare that may distract the driver or captain of the boat 18 while the boat 18 is underway. Also, the lights 12 may be replaced while the mount member 14 remains mounted in place, so that it is not necessary to remove the mount member 14 or the navigation light assembly 10 in order to change or replace a light that has burned out.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A low profile boat navigation light assembly comprising:
a mount member defining a hole in a generally central portion thereof, said mount member including attachment means for attaching said mount member to a boat adjacent a rubrail;
wherein said mount member is made of a substantially rigid material;
a light attached to an underside of said mount member so that said assembly is substantially waterproof and so that said light is recessed within said mount member; and
wires connected to said light for connection to a power source.

2. The low profile boat navigation light assembly set forth in claim 1, wherein said mount member is made from material selected from the group consisting of metal or plastic.

3. The low profile boat navigation light assembly set forth in claim 1, wherein said light is a light emitting diode.

4. The low profile boat navigation light assembly set forth in claim 1, further including a protective cover disposed over said hole in said mount member.

5. The low profile boat navigation light assembly set forth in claim 4, wherein said protective cover is transparent.

6. The low profile boat navigation light assembly set forth in claim 1, wherein said protective cover is tinted with a red color or green color.
